(19) United States
(12) Patent Application Publication
(10) Pub. No.: US 2017/0139970 A1
(43) Pub. Date: May 18, 2017

(54) METHOD FOR UPDATING A RECORD IN A DATABASE BY A DATA- PROCESSING DEVICE

(71) Applicant: BULL SAS, Les Clayes-sous-Bois (FR)

(72) Inventor: Matthieu DUFOURCQ, Les Milles (FR)

(21) Appl. No.: 15/354,355

(22) Filed: Nov. 17, 2016

(30) Foreign Application Priority Data
Nov. 18, 2015 (FR) 1502417

(51) Int. Cl. G06F 17/30

(52) U.S. Cl. CPC G06F 17/30345; G06F 17/3056; G06F 17/30525

(57) ABSTRACT

A method to update a record in a database by a data-processing device configured to implement a record-processing application, wherein the record has a structure containing a plurality of fields predetermined in the database, wherein the record is accessed by the application via a model using an object language in which the structure of a record is modelled by a class, and where each record field corresponds to a class method, the method including the following steps for each method: analysis of the method declaration as known when the application starts, in order to find at least one predetermined annotation; if the predetermined annotation is found this is followed by analysis of the annotation's parameters to produce an input control; use of the produced control to create a man-machine interface allowing entry or display of data, via the data-processing device, to update the record.

### TECHNICAL FIELD OF THE INVENTION

The object of the present invention is a method for updating a record in a database by a data-processing device.

In the present document a database is equivalent to a structured memory. A method to update a record in a memory is therefore concerned. In the present document updating includes at least creation and modification.

### STATE OF THE PRIOR ART

In the state of the art applications configured to manipulate records in databases are known. The manipulation operations are conventionally referred to by the acronym CRUD, which stands for:
C: Create;
R: Read;
U: Update;
D: Delete.

These operations are executed via man-machine interfaces, or MMI, which allow:
Visual rendering by entry/display controls (text boxes, checkboxes, list boxes, etc.);
Activation of commands via activating controls (buttons, links, events, etc.)

Use of such an MMI is therefore a part of the chain of means allowing records to be updated in a database or, more generally, the manipulation of records., whether or not the said records are persisted in a database,

Such an MMI is produced by a data-processing device executing an instruction code. An MMI is a collection of forms. A form organises input controls and activating controls. This instruction code defines a form explicitly for each type of record. In other words there are, in the instruction code for the application, at least as many form-creation instructions as there are types of record to manage. Each form-creation instruction is accompanied by a plurality of instructions to create input controls, instructions for positioning of entry controls and instructions to configure entry controls.

The size of the record manipulation code therefore depends on the number of types of record which the application must manage. To be able to update records this manipulation code must be produced and maintained. But the greater the number of lines in a code file, the longer and more complex it is to produce and maintain. Thus, applications in which a large number of types of record can be manipulated are complicated to produce, and when they are so produced can behave erroneously.

In the state of the art code scaffolding tools are known which automatically produce the basic code from a description of a database. I.e., if a database has N types of record, then the scaffolding tool will generate the code for N forms. It is then in theory possible to produce the application directly from this automatically generated code.

Although it can be produced rapidly such generated code is nonetheless still large, and therefore produces an executable which is equally large. The generated code is also very difficult to maintain. Indeed, if the generated code is customised, and if the database changes, then scaffolding generation can no longer be used without the risk of losing the customisations. The term “code customisation” is understood to mean modifications made to the generated code. This reasoning also applies when there is no database, if the data structure manipulated by the application changes.

In practice these tools are used for fast production of models. For the reasons set out above, they are not used for production of applications intended to be released to consumers, especially if the targeted consumer group is very demanding in terms of code quality such as, for example, military-type consumers.

### Account of the Invention

In the invention these problems are resolved by proposing a method of implementation based on automated production of forms using code annotations.

By this means the code corresponding to the form production can be factorised by the annotations which are shared by the types.

By this means a short application is obtained which is easy to maintain, and which enables the number of types managed to be extended, without having to produce an update interface code file.

To this end, the object of the invention is a method to update a record in a database by a data-processing device configured to implement a record-processing application, where the record has a structure containing a plurality of fields predetermined in the database, where the record is accessed by the application via a model using an object language in which the structure of a record is modelled by a class, and where each record field corresponds to a class method, characterised in that the method includes the following steps for each method:
Analysis of the method declaration as known during runtime, in order to find at least one predetermined annotation;
If the predetermined annotation is found this is followed by analysis of the annotation's parameters to produce an input control;
Use of the produced control to create a man-machine interface allowing entry or display of data, via the data-processing device, to update the record.

In addition to the main characteristics which have just been mentioned in the preceding paragraph, the method according to the invention may have one or more of the following possible additional characteristics, considered individually or in technically possible combinations:
one parameter of the predetermined annotation allows the class methods to be ordered;
one parameter of the predetermined annotation enables the type of input control to be defined;
the type of control is one from among the list formed of at least: text field, checkbox and list area;
one parameter of the predetermined annotation enables a description for the input control to be defined;
one parameter of the predetermined annotation enables a list of possible values for the input control to be defined;
one annotation targets a method or a type;
one annotation targeting a type includes a parameter to define methods targeted by the annotation;
for an annotation targeting a type, a parameter is a list of values where each value is associated with a method according to its order of appearance and the order of the definitions in the definition parameter

Another object of the invention is a digital storage device including one or more files corresponding to instruction codes implementing the method according to a possible combination of the above characteristics.

Another object of the invention is a device implementing a method according to a possible combination of the above characteristics

### BRIEF DESCRIPTION OF THE FIGURES

Other characteristics and advantages of the invention will be seen clearly on reading the description below, with reference to the appended figures, which illustrate:

FIG. 1, an illustration of an architecture allowing implementation of the invention;

FIG. 2, an illustration of steps of the method according to the invention implemented by a record-processing application.

For greater clarity, identical or similar elements are identified by identical reference signs in all the figures.

The invention will be better understood on reading the description which follows, and on examining the figures accompanying it. These are shown as an indication only, and are not restrictive of the invention in any manner.

### DETAILED DESCRIPTION OF ONE EMBODIMENT

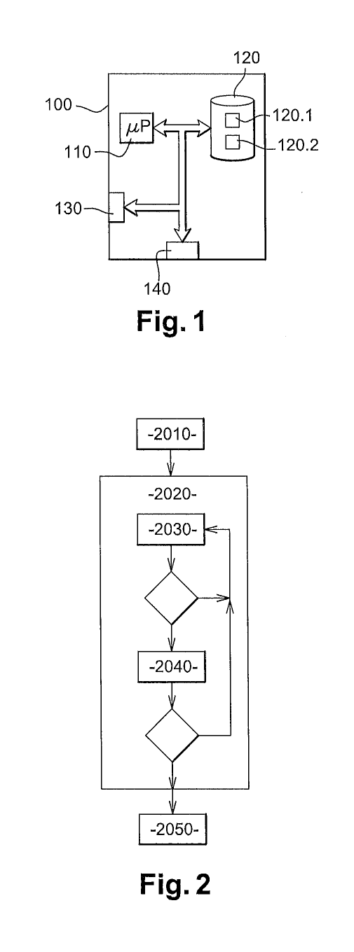

FIG. 1 shows a data-processing device 100. The data-processing device includes:
a microprocessor 110;
storage means 120, for example a hard drive, whether local or remote, and whether simple or in a schema (for example RAID). The storage means include:
   an area 120.1 including instruction codes for using the invention, i.e. instruction codes of a record-processing application;
   a record area 120.2 configured to allow structured data to be saved.
a communication interface 130, for example a communication card using the Ethernet protocol. Other protocols are conceivable, such as IP, “Fibre Channel” or InfiniBand;
a video interface 140, for example a video configured to be connected to a screen. Such a screen can also be used as in input peripheral if it is a touch-screen.

Record area 120.2 is the memory area of the man-machine interface produced by the invention. It is the area which is read and written to. It may be a database in the strict sense, or an exchange area shared by several processes. For example, such an area is modified via the man-machine interface produced according to the invention, and then the content of the said area is used by a message transmission process.

Microprocessor 110 of the data-processing device, storage means 120 of the data-processing device and communication interface 130 of the data-processing device are interconnected by a bus 150.

For the purposes of the invention a data-processing device is, for example, a desktop or laptop personal computer, a smartphone or a tablet.

When an action is imparted to a device it is in fact pefformed by a microprocessor of the device controlled by instruction codes recorded in a memory of the device. If an action is imparted to an application it is in fact performed by a microprocessor of the device in a memory where the instruction codes for the application are recorded, When a device or an application transmits a message this message is transmitted via a communication interface of the said device or of the said application. A message contains at least one destination address field, one sender address field and one payload. These principles are applicable whether the device is real or virtual.

With respect to the processing device, only the elements involved directly in implementation of the invention are represented. In particular the input-output peripherals are not represented.

FIG. 2 shows a preliminary step 2010 in which a user of the data-processing device expresses their desire to manipulate a record of a certain type, this type being chosen from among a predetermined list present in the record-processing application, This list is established by means of a declaration when the application is programmed. In preliminary step 2010 the user chooses a type of record.

The type chosen in preliminary step 2010 is used to produce a man-machine interface. The chosen type is used in a loop 2020 which is repeated for each method of the chosen type.

It should be noted that a record is formed from a plurality of fields. In the invention a record is associated with a type which is called a “record type”, where each field is associated with a method of the type.

For example, for :a field, exposed via a method, the getter method and the setter method are obtained via the type returned by the method. A method of a class used to model a field of a record has a signature resembling:
TypeGénérique<Type>nomMethode( )

In this signature “TypeGénérique” is a type exposing a setter method and a getter method, and “Type” is a type of data element or field. A Type of a data element or a type of field is, for example: text, date, time, coordinate, number, etc.

The term “exposed” in this case means that its value is made available with read/write access.

The steps of loop 2020 are accomplished for each method of the type selected in the preliminary step. The list of methods is obtained by the technique of reflection applied to the type.

FIG. 1 shows that loop 2020 includes a step 2030 for analysing the method's declaration. This declaration is the one which was written when the application was designed, and compiled when it was produced, and which is therefore present in the application. This declaration can be obtained by use of the technique of reflection. This declaration is therefore known when the application starts; the expression “known at runtime” is also used. The application does not need to go in search of it elsewhere, for example in a configuration file.

This declaration is also necessarily correct, since it had to be analysed by a compiler to enable the application to be produced.

The analysis of the method enables a list of annotations to be produced which were associated with the method when the application was designed. According to a Java formalism such a method is written as follows:
©Form2(
index=8,
label=“Nationality”,
componentType=CT,combobox,
enumType={©DEnumTypeRestriction(type=DEnumType.L105_2)},
classesRestriction={“GroundTrack”, “SeaTrack”, “AirTrack”})
TacticalObjectProperty<DEnum>nationality( )

In this example a method with the name “nationality” is associated with an annotation with the name “Form2”.

If such an annotation is found the next step is a step 2040 of production of an input control. In step 2040 of production of an input control parameters of the annotation are analysed to determine the characteristics of the input control which must be produced.

The above example shows that the annotation contains the following named parameters:
“index”: a parameter enabling the order in which the produced controls must be positioned in a form;
“label”: a parameter enabling a caption for the input control to be defined;
“componentType”: enables the type of input control which must be produced to be defined. The most common types of input control are:
   text box;
   checkbox;
   list area;
“enumType”: enables a pre-existing list of possible values for the entry control to be defined;
“classesRestrictions”: enables use of a method to be restricted to a given type, or to a list Of types. This restriction is for the case in which the annotations of a type are obtained by inheritance from another type or from an interface, where the term “interface” is used in this case in the information technology sense of the term, and corresponds to the Java keyword “interface”.

The names of the parameters are given as examples.

An initial value of an input control is determined by invoking the getter method obtained via the analysed method. It should be noted that an input control is a known concept, and that such a control enables a user to display or enter a value.

As long as methods remain to be analysed the loop continues. After this the next step is a step 2050 of creation of a man-machine interface.

In step 2050 the input controls produced during loop 2020 are arranged in order to produce a form which is displayed to enable the user to manipulate the record.

The form also includes controls of the button type to activate CRUD actions.

With this invention production of a form is therefore undertaken by means of a function which takes a type as a parameter. This function analyses this type in order to find annotations in it relating to the production of an input form. The said annotations are defined when the application is produced. The application can therefore be produced only if the annotations are validated by the application's production environment. In the invention there is therefore no risk of an error relating to an error in run parameters.

When this function has been validated as many record types as desired can be added; the resulting forms will be error-free.

The type analysed is obtained by reflection on an instance of a class of the type selected in the preliminary step. A instance of a type is a memory area the content of which is interpreted as the type of the instance. This instance may be obtained, for example, by:
Simple allocation of an object by a direct use of an allocator; in the case of Java this is the keyword “new”;
Use of an ORM (Object-Relational Mapping), which is a tool enabling a link to be made between a database and an object model.

An implementation of the invention has just been described with annotations targeting methods. It is also possible to implement the invention using annotations targeting a type.

For example, the following code extract:
©Form1(indexes={3}, methods={FLM.isHuman},
   classesRestriction={“GroundTrack”, “SeaTrack”, “AirTrack”})
public interface Track<T extends Track<T>>extends TacticalObject<T>{
   ©Form2(
      index=8,
      label=“Nationality”,
      componentType=CT.combobox,
      enumType={@DEnumTypeRestriction(type=DEnumType. L105_2)},
      classesRestriction={“GroundTrack”, “SeaTrack”, “AirTrack”})
   TacticalObjectProperty<DEnum>nationality( )
   TacticalObjectProperty<Boolean>isHuman( )
}

Illustrates the fact that the annotations for a method, in this case “isHuman” of a type, can be attributed via the type.

This means that in step 2030 of analysis of the method declaration the type declaration is also inspected to determine whether the type includes annotations targeting the method.

In the invention the targeting of a type annotation is determined in this manner using the named designation parameter; in the example, “methods”. The designation parameter includes a list of target methods of the type annotation.

The type annotation includes other parameters, which are also lists of values. For a given method a position index in the list of the designation parameter is determined. When this position index is known it will be used with the other type annotation parameters to determine the parameter values corresponding to the method.

Thus, if a method has an index I in the list of values of the designation parameter, then the value of the “index” method parameter for this method will be the value located at index I in the list of values of the type parameter named “indexes”. A pluralisation convention is being used here to associate a parameter of a type annotation with a parameter of a method annotation. Other strategies can be used to achieve this association. For example, an association coded statically with a conditional expression:
If the type parameter is called XXX then this corresponds to method parameter YYY.

In this description we have use Java in the examples, but the invention remains a valid with other languages, such as C# or delphi, which allow code to be decorated with annotations.

1. A method to update a record in a database by a data-processing device configured to implement a record-processing application, wherein the record has a structure containing a plurality of fields predetermined in the database, wherein the record is accessed by the application via a model using an object language in which the structure of a record is modelled by a class, and wherein each record field corresponds to a class method, the method comprising for each class method:
analysing the method declaration as known during runtime, in order to find at least one predetermined annotation;
if the predetermined annotation is found, analysing the annotation's parameters to produce an input control;
using the produced control to create a man-machine interface allowing entry or display of data, via the data-processing device, to update the record.

2. The method for updating a record in a database according to claim 1, wherein a parameter of the predetermined annotation enables the methods of the class to be ordered,

3. The method for updating a record in a database according to claim 1, wherein a parameter of the predetermined annotation enables the type of input control to be defined.

4. The method for updating a record in a database according to claim 3, wherein the type of control is from a list consisting of at least: text box, checkbox, list area.

5. The method for updating a record in a database according to claim 1, wherein characterised in that a parameter of the predetermined annotation enables a description for the input control to be defined.

6. The method for updating a record in a database according to claim 1, wherein a parameter of the predetermined annotation enables a list of possible values for the input control to be defined.

7. The method for updating a record in a database according to claim 1, wherein an annotation targets a method or a type.

8. The method for updating a record in a database according to claim 1, wherein an annotation targeting a type includes a parameter to designate methods targeted by the annotation.

9. The method for updating a record in a database according to claim 8, wherein, for an annotation targeting a type, a parameter is a list of values where each value is associated with a method according to its order of appearance and the order of the definitions in the definition parameter.

10. A non-transitory digital storage device containing one or more files containing instruction codes implementing the method according to claim 1.

11. A device implementing the method according to claim 1.
